(19) United States
(12) Patent Application Publication
(10) Pub. No.: US 2025/0233682 A1
(43) Pub. Date: Jul. 17, 2025

(54) PERFORMANCE MONITORING DATA INTEGRATED ROUTE PLANNING TOOL FOR RECONFIGURABLE OPTICAL ADD-DROP MULTIPLEXER (ROADM) DENSE WAVELENGTH-DIVISION MULTIPLEXING (DWDM) NETWORKS

(71) Applicant: AT&T Intellectual Property I, L.P., Atlanta, GA (US)

(72) Inventor: Guodong Zhang, Manalapan, NJ (US)

(73) Assignee: AT&T Intellectual Property I, L.P., Atlanta, GA (US)

(21) Appl. No.: 18/415,193

(22) Filed: Jan. 17, 2024

(51) Int. Cl. H04J 14/02

(52) U.S. Cl. CPC H04J 14/021; H04J 14/0215

(57) ABSTRACT

Aspects of the subject disclosure may include, for example: receiving traffic pattern data/parameters associated with a reconfigurable optical add-drop multiplexer (ROADM) dense wavelength-division multiplexing (DWDM) network; defining a configuration of the network based upon the traffic pattern data/parameters; outputting the configuration to facilitate physical provisioning and operation of ROADM nodes (and one or more ILA(s), if any) according to the configuration; receiving performance monitoring (PM) data indicative of operation of the network as configured according to the configuration; defining an updated configuration of the network that is based upon the PM data, wherein the updated configuration adds to the network at least one pair of transponders, at least one regenerator, or a combination thereof; and outputting the updated configuration to facilitate physical updating of the network in a manner such that the transponders, the regenerator(s), or the combination thereof is placed into operation. Other embodiments are disclosed.

### FIELD OF THE DISCLOSURE

The subject disclosure relates to a performance monitoring data integrated route planning tool for reconfigurable optical add-drop multiplexer (ROADM) dense wavelength-division multiplexing (DWDM) networks.

### BACKGROUND

Reconfigurable optical add-drop multiplexer (ROADM) dense wavelength-division multiplexing (DWDM) systems are widely deployed in various high-capacity, complex, and dynamically configured optical networks. FIG. 1A shows a simple example of a conventional OADM DWDM system 1000, which has five ROADM nodes (A, B, C, D, E). The transmission is bidirectional, one fiber carries the DWDM optical signals from east to west (that is, from right to left in this figure) and another fiber carries the signals in the opposite direction. The ROADMs can typically support 80 or more wavelengths in each direction. In this example, ROADM nodes A and E are three-degree ROADM nodes, and ROADM nodes B, C and D are two-degree nodes. For the ROADM nodes, the wavelengths can be routed to one of the multiple directions. For example, the wavelengths from the transponders or regenerators at ROADM node B can be transmitted (and received) to (and from) the ROADM node A. or C, or E as needed. The multi-degree ROADM nodes also enable the wavelengths to pass-through (or express-through) the node if the wavelengths do not need to be added/dropped. For example, the wavelengths between the ROADM node A and C and between node E and C can express-through the ROADM node B if needed. The in-line optical amplifier (ILA) nodes (shown here as elements 1002, 1003, 1004, 1005, 1006) are used to boost the DWDM signal strength along in the fiber path when the distance between the adjacent ROADM nodes is too long (or the fiber loss is too high), but add extra noise as well to the signal. Of note, there can be situations in which an ILA is not required between ROADM nodes. Connecting through IP network switch 1008, the ROADM nodes and transponder nodes can be managed by an element management system (EMS) 1010, and can also be accessed and/or provisioned via craft interface(s) 1012. In addition, the ILA nodes can be indirectly accessed and managed via the optical supervisory channel (OSA) channels from the nearby ROADM nodes. The EMS 1010 allows operators to retrieve alarms and performance monitoring (PM) data, etc. to monitor the deployed ROADM DWDM nodes and associated components. Furthermore, the northbound operation systems (OSS) 1014 can connect to the EMS 1010 for the purposes of ordering, ticketing, inventorying, etc.

In various configurations, the ROADM and ILA nodes are managed by one EMS, and the transponder nodes can be managed by the same EMS or by different EMS (the EMS systems can reside in a server and/or in different servers).

The transponders and regenerators are responsible for transmitting customers' services from one location to another location, and are typically the major cost for the ROADM DWDM systems.

Referring now to FIG. 1B, this shows a generalized building block of a conventional transponder 1100, which comprises a client side optics 1102 and a line side optics 1104. The client optics is connected (via fiber) to the optics in the customer premises, and the client optics' optical signals are usually compliant to industry standard protocols, e.g., long reach 100 Gbps ethernet. Each transponder converts the received client optical signal (carrying client payloads) via the O-E-O (optical to electrical to optical) processing to DWDM line signal at provisioned wavelength (λₙ) in the transmitter side to one of the multiplexer ports of ROADMs, and also converts the received DWDM signal (from one of the demultiplexer ports of ROADMs) to client signal via O-E-O processing. The line side optics' signals are usually vendor specific or follow multi-source-agreement (MSA), and have specific modulation scheme and forward error correction (FEC) code, etc.

The key parameter of line side optics 1104 is the required minimum OSNR (optical signal to noise ratio), the lower the better. Usually, the high-performance transponder has lower OSNR requirement and is more expensive than those of the low performance ones. The higher the transmission rate is, the higher OSNR is required for the received DWDM signal to achieve error-free operation.

When the wavelength's signal quality (usually referred to as the optical signal to noise ratio, i.e., OSNR) is not good enough (or is too noisy) to achieve error-free transmission between the transponders at two end ROADM locations, the regenerators are needed at one or several intermediate ROADM locations to clean-up the signal and to re-transmit the signal via O-E-O processing. The general building block of a conventional regenerator 1200 is shown in FIG. 1C, which shows that the regenerator 1200 comprises two line side optics (1202, 1204). The incoming DWDM signal (λₙ) received at right side optics (1202) is converted to electrical signals and cleaned up via FEC decoding processing, then the cleaned electrical signal is converted to another DWDM optical signal with FEC coding and transmitted at desired wavelength (λₙ or λₘ). The wavelength of right side line optics (1202) can be different from that of the left side line optics (1204) if needed, but often they are the same to make the wavelengths easier to trace. The same O-E-O processing is performed for the wavelength in the opposite direction (from left to right in this figure).

For high speed (10 Gbps and higher) DWDM transmission systems, the signal quality at receiver is usually too poor to achieve error-free transmission (BER less than 10⁻¹⁵) even for short distance. Then, forward error correction (FEC) technologies are typically applied to correct the bit errors to ensure error-free transmission.

The highest BER before FEC that can be corrected to a BER better than 10⁻¹⁵ is referred to as the FEC limit or FEC threshold. The BER before FEC is typically named as preFEC BER, and the BER after FEC as postFEC BER. Depending on the FEC technology which the transponders/regenerators implement, different FEC coding schemes have different FEC threshold values. For example, the Reed-Solomon (RS) FEC code RS(255, 238) was the earliest adaption of FEC in optical long haul transmission. This Reed-Solomon FEC code has been specified in ITU-T G.975, and can correct a preFEC BER up to 5.0×10⁻⁵ to postFEC error-free and yield net coding gain (NCG) of 6.2 dB. In the current optical transmission, open FEC (oFEC) is generally implemented, and can correct a preFEC BER up to 2.0×10⁻² (with a NCG of 11.1 dB).

Each type of transponder (or regenerator) has its own minimum OSNR requirement based on its FEC technology, modulation scheme and transmission rate. The received line optical signal's OSNR has typically been planned to be a bit higher than the minimum OSNR required to ensure error-free transmission for many years to come to account for adverse impacts (e.g., hardware degradation), the difference between these two OSNR values is usually referred to as targeted OSNR margin.

The measured PreFEC BER at line side receiver is directly correlated to the DWDM signal's OSNR, the difference between this indirectly measured OSNR and the required minimum OSNR is the measured OSNR margin which is always higher than the targeted OSNR margin (the shorter the signal transmits over the fiber path, the higher OSNR margin remains for the transponder/regenerator).

In today's optical networks, the wavelengths are continuously added (even deleted for some cases) and service demands grow into new locations. The deployment and operation of optical networks becomes very complicated and challenged due to its dynamic nature. Route planning is traditionally an essential part (and the initial step) of ROADM DWDM network deployment and operation for the purpose of efficiency and cost effectiveness (such route planning traditionally designs hardware placement and wavelength assignment and routing).

When the first service demand between two locations is input into a conventional route planning tool, such conventional route planning tool will assign ROADM and ILA placement along the fiber path based on traffic patterns, fiber parameters, ROADM/ILA parameters and OSNR requirements of transponders/regenerators. Such a conventional route planning tool will also assign transponders placement at the two end ROADM locations and regenerators (if needed) at intermediate ROADM nodes. For the following service requests along the deployed routes, such a conventional route planning tool will assign the transponders and regenerators (if needed) at the deployed ROADM nodes.

Further, such a conventional route planning tool is traditionally a standalone program, and is traditionally utilized independent of the operation of deployed ROADM networks. Rather, such a conventional route planning tool usually operates based on the assumptions of worst case fiber losses and connector losses, worst case of noise figures of ILA and ROAMD nodes, worst case OSNR requirement of the transponders/regenerators, and worst case of fiber nonlinear impairments, etc. Due to these traditional conservative approaches, some unnecessary regenerators and expensive (rather than low cost) transponders were deployed.

### BRIEF DESCRIPTION OF THE DRAWINGS

Reference will now be made to the accompanying drawings, which are not necessarily drawn to scale, and wherein:

FIG. 1A shows a simple example of a conventional ROADM DWDM system.

FIG. 1B shows a generalized building block of a conventional transponder.

FIG. 1C shows a generalized building block of a conventional regenerator.

FIG. 2A is a block diagram illustrating an example, non-limiting embodiment of a planning tool operational process in accordance with various aspects described herein.

FIG. 2B is a block diagram illustrating an example, non-limiting embodiment of a planning tool operational process in accordance with various aspects described herein.

FIG. 2C is a block diagram illustrating an example, non-limiting embodiment of a planning tool implementation (in which cost savings can be achieved) in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 2F depicts an illustrative embodiment of a method in accordance with various aspects described herein.

### DETAILED DESCRIPTION

The subject disclosure describes, among other things, illustrative embodiments for a performance monitoring data integrated route planning tool for ROADM DWDM networks for cost saving. Other embodiments are described in the subject disclosure.

One or more aspects of the subject disclosure include mechanisms to integrate the performance monitoring data of deployed wavelengths into a route planning tool for ROADM DWDM networks to optimize the route planning for new wavelengths for cost saving, which can eliminate the deployment of unnecessary regenerators and replace the expensive transponders by less costly ones.

One or more aspects of the subject disclosure include a non-transitory machine-readable medium comprising executable instructions that, when executed by a processing system including a processor, facilitate performance of operations, the operations comprising: receiving traffic pattern data; receiving parameters associated with components that will be part of a reconfigurable optical add-drop multiplexer (ROADM) dense wavelength-division multiplexing (DWDM) network; defining a configuration of the ROADM DWDM network, wherein the defining of the configuration is based upon the traffic pattern data and the parameters, and wherein the configuration that is defined includes a plurality of ROADM nodes; outputting the configuration that is defined in order to facilitate physical provisioning and operation of the plurality of ROADM nodes according to the configuration; receiving performance monitoring (PM) data that is indicative of operation of the ROADM DWDM network as configured according to the configuration; defining an updated configuration of the ROADM DWDM network, wherein the defining of the updated configuration is based at least in part upon the PM data, and wherein the defining of the updated configuration adds to the ROADM DWDM network at least one pair of transponders, at least one regenerator, or a combination thereof; and outputting the updated configuration that is defined in order to facilitate physical updating of the ROADM DWDM network in a manner such that the at least one pair of transponders, the at least one regenerator, or the combination thereof is placed into operation.

One or more aspects of the subject disclosure include a non-transitory machine-readable medium comprising executable instructions that, when executed by a processing system including a processor, facilitate performance of operations, the operations comprising: receiving a first service request; responsive to the first service request, obtaining traffic pattern data; responsive to the first service request, obtaining parameters associated with components that will be part of a reconfigurable optical add-drop multiplexer (ROADM) network; responsive to the first service request, generating a configuration of the ROADM network, wherein the generating of the configuration is based upon the traffic pattern data and the parameters, and wherein the configuration that is generated includes a plurality of ROADM nodes; outputting the configuration that is generated in order to facilitate physical provisioning and operation of the plurality of ROADM nodes according to the configuration; obtaining first performance monitoring (PM) data that is indicative of operation of the ROADM network as configured according to the configuration; generating a first updated configuration of the ROADM network, wherein the generating of the first updated configuration is based at least in part upon the first PM data, wherein the generating of the first updated configuration adds to the ROADM network at least one first pair of transponders, at least one first regenerator, or a first combination thereof, and wherein the first updated configuration is associated with a first wavelength; outputting the first updated configuration that is generated in order to facilitate physical updating of the ROADM network in a manner such that the at least one first pair of transponders, the at least one first regenerator, or the first combination thereof is placed into operation; receiving a second service request; responsive to the second service request, obtaining second PM data that is indicative of operation of the ROADM network as configured according to the first updated configuration; responsive to the second service request, generating a second updated configuration of the ROADM network, wherein the generating of the second updated configuration is based at least in part upon the second PM data, wherein the generating of the second updated configuration adds to the ROADM network at least one second pair of transponders, at least one second regenerator, or a second combination thereof, and wherein the second updated configuration is associated with a second wavelength that is different from the first wavelength; and outputting the second updated configuration that is generated in order to facilitate physical updating of the ROADM network in a manner such that the at least one second pair of transponders, the at least one second regenerator, or the second combination thereof is placed into operation.

One or more aspects of the subject disclosure include a method, comprising: receiving, by a processing system including a processor, a service request associated with a new route in a reconfigurable optical add-drop multiplexer (ROADM) dense wavelength-division multiplexing (DWDM) network; responsive to the service request, obtaining, by the processing system, traffic pattern data; responsive to the service request, obtaining, by the processing system, fiber parameters associated with the new route; responsive to the service request, generating, by the processing system, a configuration of the network for the new route, wherein the generating of the configuration is based upon the traffic pattern data and the fiber parameters; outputting, by the processing system, the configuration that is generated in order to facilitate physical provisioning and operation of a plurality of ROADM nodes of the new route according to the configuration; obtaining, by the processing system, performance monitoring (PM) data that is indicative of operation of the network along the new route as configured according to the configuration; generating, by the processing system, an updated configuration of the network, wherein the generating of the updated configuration is based at least in part upon the PM data, wherein the generating of the updated configuration adds to the network along the new route at least one pair of transponders, at least one regenerator, or a combination thereof, and wherein the updated configuration is associated with a wavelength used in the new route; outputting, by the processing system, the updated configuration that is generated in order to facilitate physical updating of the network along the new route in a manner such that the at least one pair of transponders, the at least one regenerator, or the combination thereof is placed into operation; and obtaining, by the processing system, other PM data that is indicative of operation of the network along the new route as configured according to the updated configuration.

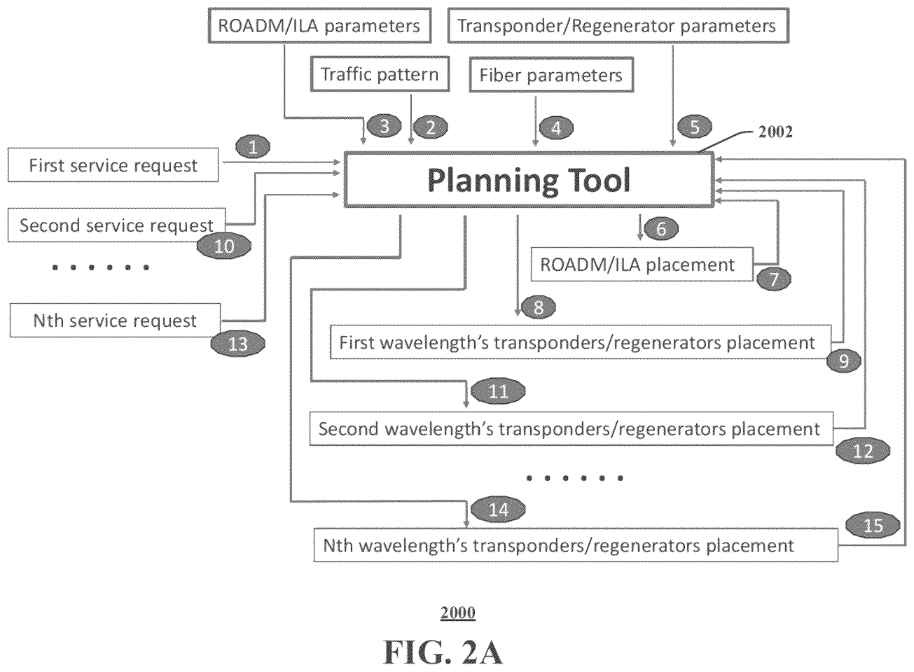

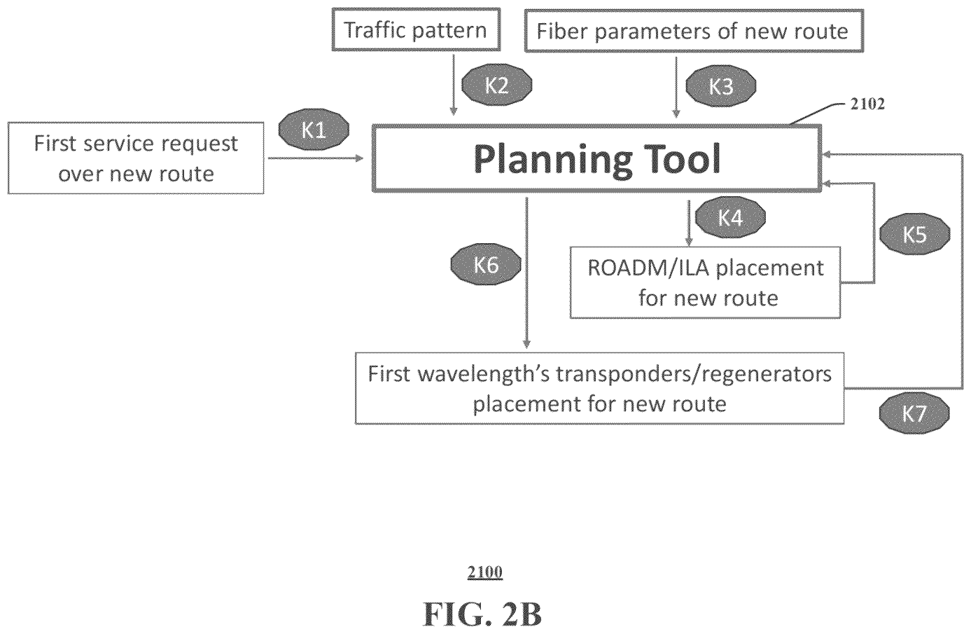

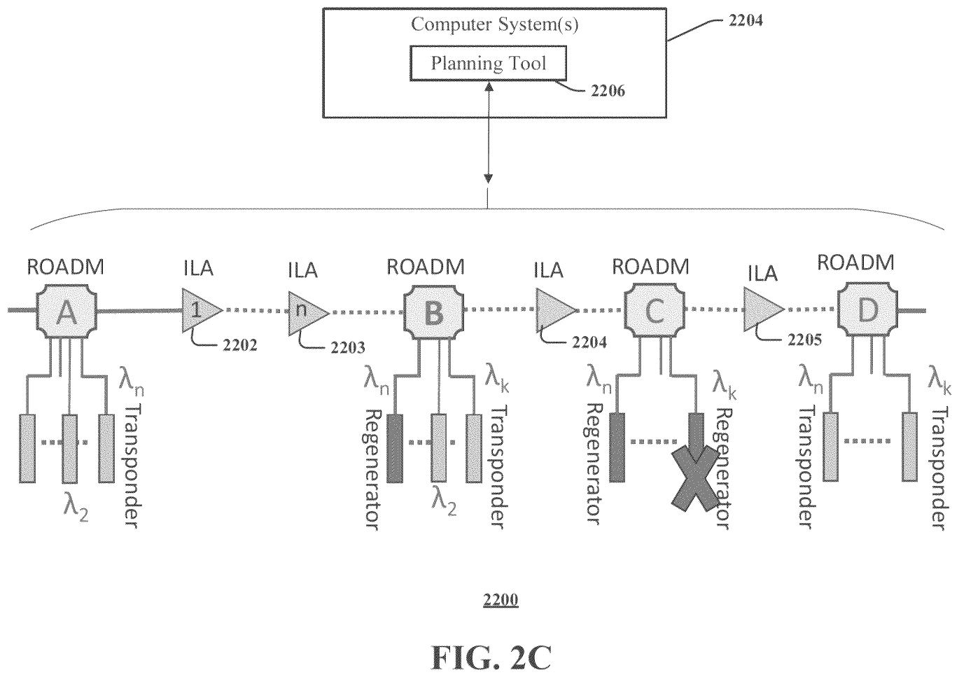

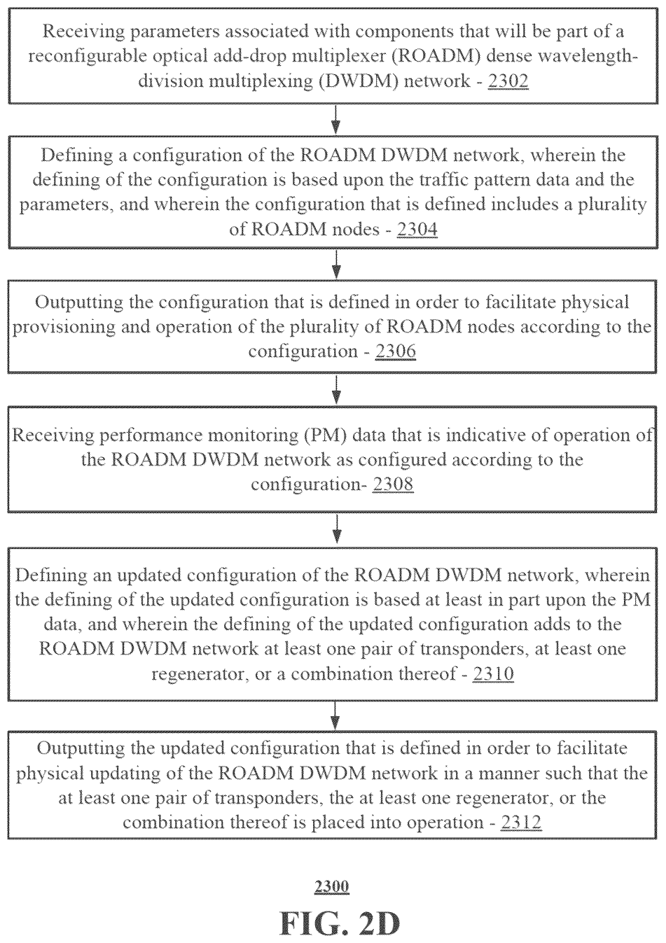

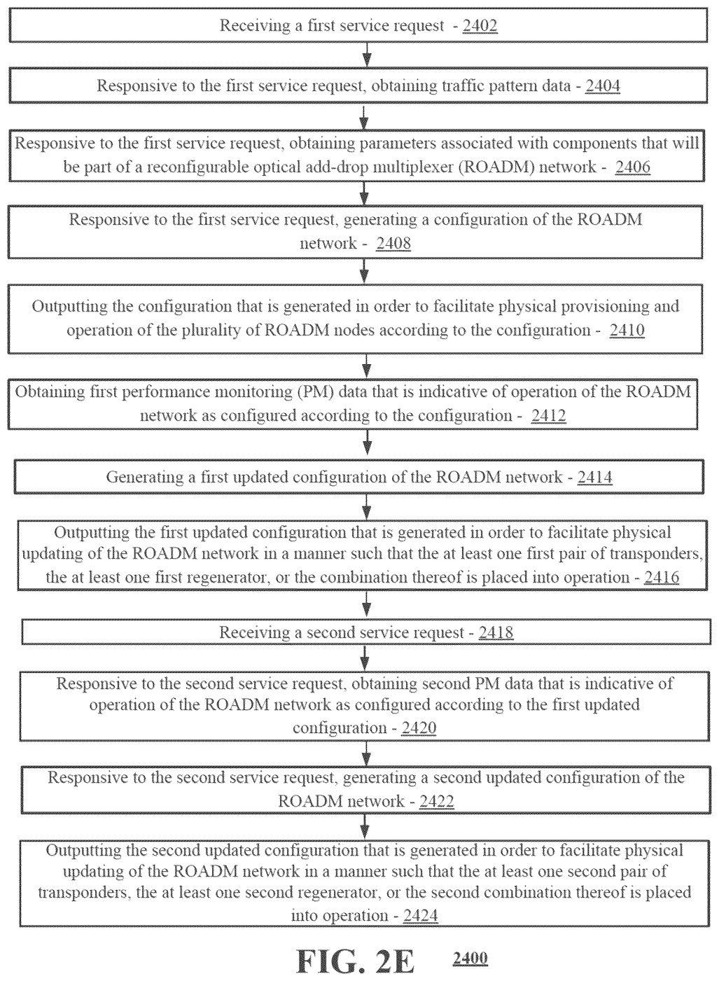

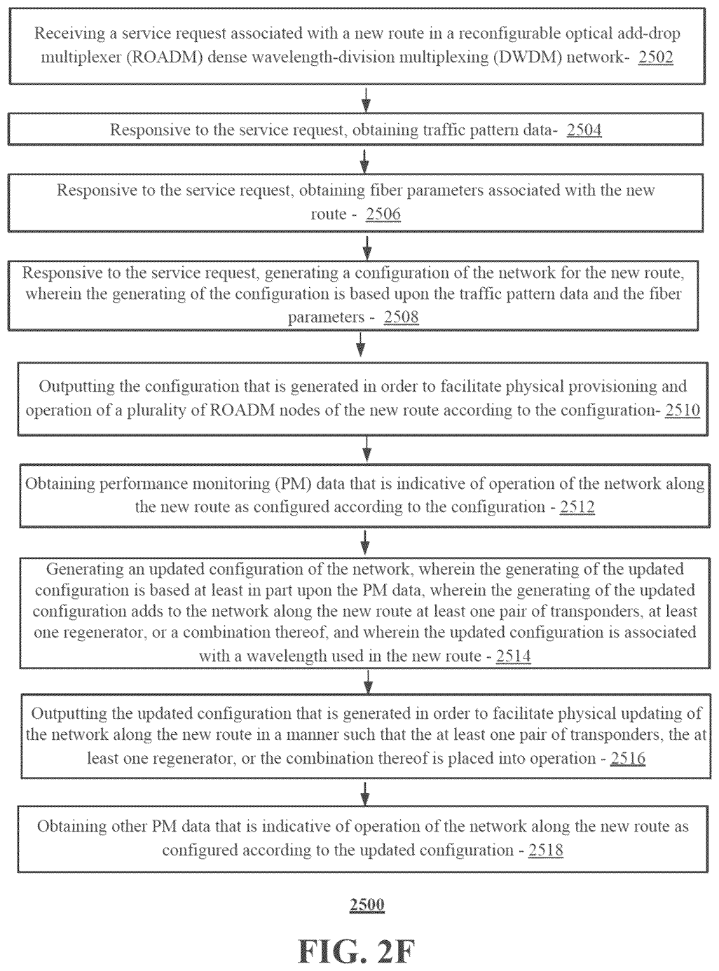

Referring now to FIG. 2A, this is a flow chart related to a performance monitoring data integrated route planning tool for ROADM DWDM systems (according to an embodiment). In operation, in a green field application, when the first service demand between two locations is requested (Step_1), the previous and anticipated traffic pattern along the path between the locations are input (Step_2) to decide ROADM node placements at various locations by the Planning Tool 2002. In various examples, the Planning Tool 2002 can comprise software that runs on one or more computing systems, one or more computers, one or more servers, one or more processing systems, one or more processors, or the like.

Further, since the ROADM nodes' characteristics (as well as the characteristics of any ILAs that are utilized) will define the OSNR for the link between the two locations, each ROADM (and ILA, where applicable) node's parameters (e.g., gain, noise figure (NF), polarization dependent loss (PDL), etc.) are input to the Planning Tool 2002 (Step_3).

Further still, in order to decide the ILA placements (where applicable), the Planning Tool 2002 receives as input the fiber parameters (e.g., fiber types, measured or estimated fiber attenuation, chromatic dispersion (CD), polarization mode dispersion (PMD), optical return loss (ORL)) for each fiber section along the link between the two locations (Step_4).

Further still, since the demanded service will be carried by transponders at the two end locations, the Planning Tool 2002 receives as input the transponder and regenerator parameters (such as the minimum OSNR requirements) to place the transponders and regenerators (Step_5).

With all the above-mentioned steps performed, the Planning Tool 2002 will designate the ROADM (and ILA, where applicable) locations, and generate the bill of materials (BOM) for the ROADM (and ILA, where applicable) nodes (Step_6).

Thereafter, the operational personnel will install the nodes, and connect the nodes with planned fibers. After the nodes are turned-up and provisioned, the Planning Tool 2002 can retrieve the PM (performance monitoring) data of the ROAMD nodes (and ILA nodes, if utilized), wherein this PM data can include span loss values for each section between adjacent ILAs (if utilized) and between adjacent ROADM and ILA (if utilized) nodes and between two adjacent ROADM nodes (if there is no ILA between them) from EMS (Step_7). Then, the Planning Tool 2002 can update the span loss for each span.

With updated span losses, the Planning Tool 2002 then decides the placements of transponders and regenerators (if needed) based on the OSNR requirements, assigns the wavelength for them, and generates BOM for them (Step_8).

After the transponders and regenerators are installed, connected to the multiplexer/demultiplexer ports to the ROADM nodes, and provisioned, the transmission for the first service should be error-free (postFEC). The Planning Tool 2002 can retrieve PM (performance monitoring) data of the transponders and regenerators via EMS, wherein this PM can include preFEC BER and postFEC BER, and even total CD, PMD and PDL values, etc. (Step_9).

Further, the CD, PMD and PDL values of retrieved PM can be used to update the previous values based on fiber/ROADM/ILA parameters in the Planning Tool 2002. Since the preFEC BER is directly correlated to OSNR, the real-time preFEC BER from the retrieved PM data can provide accurate calculation of OSNR margin for the transponders and regenerators for their corresponding optical transmission links. Usually, the OSNR margin is much higher than the targeted values from the Planning Tool 2002 due to the very conservative input parameters of ROADM, ILA, transponder/regenerator and fibers/connectors.

When the second request is presented (Step_10), the Planning Tool 2002 will use the updated OSNR margin, updated CD/PMD/PDL to design placements of the transponders and regenerators (if needed), assigns the wavelength for them, and generates BOM for them (Step_11).

Since the Planning Tool 2002 (according to various embodiments) uses the updated OSNR margin, updated span losses, updated CD/PMD/PDL, the number of regenerators for this service could have been reduced compared to a conventional planning tool without the PM data integration that is provided by such embodiments.

Following the same procedure as the first service, the Planning Tool 2002 can retrieve the PM data of the transponders and regenerators for the second service via (Step_12) and update the OSNR margin, CD, PMD and PDL.

For the sequential service requests, the Planning Tool 2002 iterates the same procedures as the second service request. The Planning Tool 2002 repeatedly retrieves the real-time PM data and updated OSNR margin, CD, PMD and PDL for each new service activated. Then the Planning Tool 2002 becomes more accurate as more transponders and regenerators are deployed.

Sometimes, the customers may not need the services anymore, then the services need to be removed, and the transponders and regenerators need to be de-commissioned from the optical network. In any case, the Planning Tool 2002 can still keep the PM data from these de-commissioned transponders and regenerators in order to optimize route planning for new services.

As described herein, while ROADM DWDM networks are usually deployed in the beginning in one geographic region and/or simply in a point-to-point or ring configuration, the ROADM DWDM networks often grow into larger regions and complex mesh networks. FIG. 2B shows a flow chart (according to an embodiment) of PM data integrated route planning for ROADM DWDM networks expanding into new locations.

Still referring to FIG. 2B, when the first service request in the new locations is presented (Step_K1) the input traffic patterns at the new locations (Step_K2) allow the Planning Tool 2102 to assign the ROADM node placement, and the input fiber parameters (Step_K3) enable the Planning Tool 2102 to design ILA node placements (if applicable) along the fiber path for this service in the new locations.

Based on the ROADM (and ILA, if applicable) node placements (Step_K4) generated by the Planning Tool 2102, the nodes for the new location will be installed, turned-up and provisioned, and the Planning Tool 2102 can retrieve the PM data of the nodes from EMS (Step_K5). Then, the Planning Tool 2102 can update the span loss for each span along the fiber path for this service.

With updated span losses in the new locations and updated OSNR margin information from the services deployed in other locations, the Planning Tool 2102 then decides the placements of transponders and regenerators (if needed), assigns the wavelength for them, and generates BOM for them (Step_K6).

After the transponders and regenerators are installed, turned-up and provisioned, the Planning Tool 2102 can retrieve the PM data of the transponders and regenerators via EMS (Step_K7), and integrate the PM data for more accurate design for future service requests.

Further, for the second and sequential service demands in the new locations, the Planning Tool 2102 can follow similar steps as those just described in connection with FIG. 2A.

Referring now to FIG. 2C, this figure shows certain implementation details associated with a ROADM DWDM system 2200 in which cost savings can be achieved using a planning tool of an embodiment in accordance with various aspects described herein.

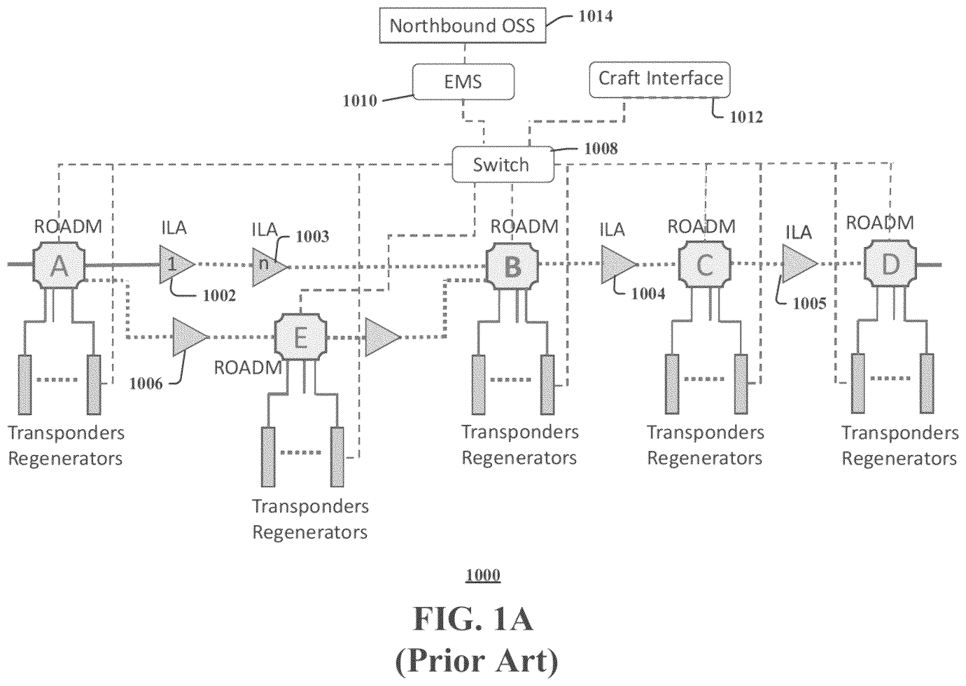

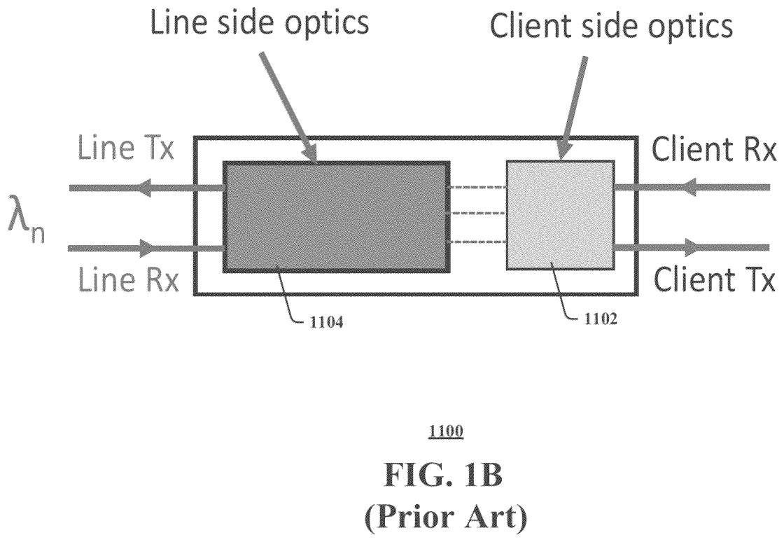

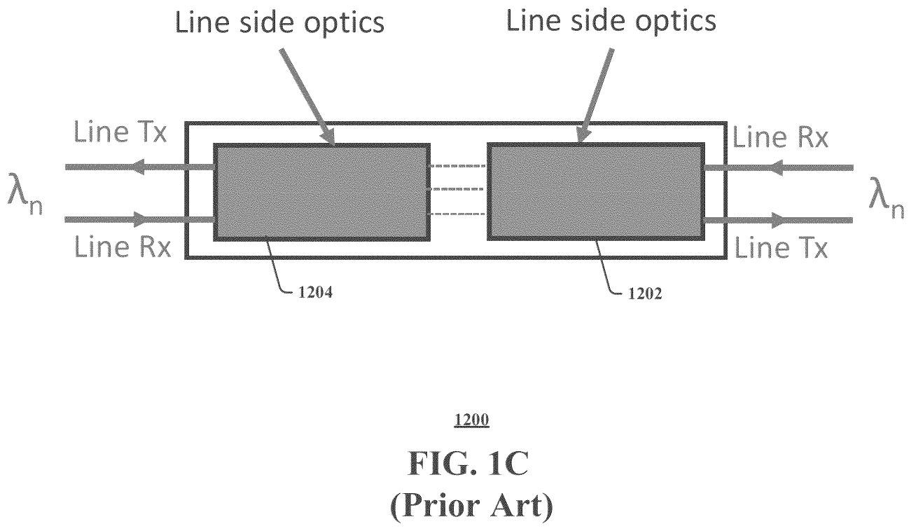

In order to demonstrate the cost saving merit of various embodiments (e.g., with regard to transponder and regenerator placements for new service), a number of examples are discussed. In one example, for a ROADM DWDM system of this figure (some of which components are similar to components of FIG. 1A), the expensive type transponders between the ROADM node A and B are placed and deployed for the first wavelength. The PM data retrieved by Planning Tool 2206 indicates that the OSNR margin is much higher than planned, and the low cost transponders can be used to meet its OSNR margin. Then, the Planning Tool 2206 can assign the low cost transponders for the new services (λₙ) between the ROADM A and B.

Still referring to FIG. 2C, in another example, based on the retrieved PM data, if the updated OSNR can meet the OSNR margin requirements for a higher rate transmission in the same link, the Planning Tool 2206 can assign transponder placements for future higher rate service demands between ROADM A and B. Consequently, the capacity of this link can be increased.

Still referring to FIG. 2C, in another example, assuming there is a service demand (λₙ) between ROADM A and D, and the wavelength is the first one between ROADM B and D, and the OSNR is slightly shorter of margin from the transmission from ROADM B and ROADM D, the Planning Tool 2206 can place the transponders at ROADM A and D to connect with customer' client signals, and regenerators at ROADM B and C. The PM data retrieved by Planning Tool 2206 in this example indicates that the link from ROADM B and C and the link from C to D have much more OSNR margin than targeted ones at the regenerator and transponder, the updated OSNR between ROADM B and D can meet the OSNR margin requirement without a regenerator at ROADM C. Then, when there is a new service request between ROADM B and D, the Planning Tool 2206 can just assign transponder placement at ROADM B and D, and let the wavelength (λₙ) express-through ROADM B without a regenerator, which is a significant cost saving.

Still referring to FIG. 2C, in various embodiments, the Planning Tool 2206 can comprise software, and the software of Planning Tool 2206 can operate on one or more Computer Systems 2204 (which can be cloud-based, can be stand-alone compute(s), can be server(s), or any combination thereof).

As described herein, various embodiments provide two sets of PM data: (1) PM data from ROADM/ILA (e.g., span loss), which is provided as feedback and which is integrated into the route planning tool; and (2) PM data from transponder/regenerator (e.g., preFEC BER, postFEC BER, CD/PDM/PDL), which is provided as feedback and which is integrated into the route planning tool.

Of course, any desired number of iterations (e.g., iterations regarding a plurality of wavelengths, iterations regarding a plurality of routes, iterations regarding a plurality of ROADM nodes, iterations regarding a plurality of ILA nodes, iterations regarding a plurality of transponders, and/or iterations regarding a plurality of regenerators) can be implemented.

As described herein, various embodiments can operate in the context of one or more virtual machines in the cloud (e.g., wherein the cloud has the infrastructure supported by one or more data centers).

Referring now to FIG. 2D, various steps of a method 2300 according to an embodiment are shown. As seen in this FIG. 2D, step 2302 comprises receiving parameters associated with components that will be part of a reconfigurable optical add-drop multiplexer (ROADM) dense wavelength-division multiplexing (DWDM) network. Next, step 2304 comprises defining a configuration of the ROADM DWDM network, wherein the defining of the configuration is based upon the traffic pattern data and the parameters, and wherein the configuration that is defined includes a plurality of ROADM nodes. Next, step 2306 comprises outputting the configuration that is defined in order to facilitate physical provisioning and operation of the plurality of ROADM according to the configuration. Next, step 2308 comprises receiving performance monitoring (PM) data that is indicative of operation of the ROADM DWDM network as configured according to the configuration. Next, step 2310 comprises defining an updated configuration of the ROADM DWDM network, wherein the defining of the updated configuration is based at least in part upon the PM data, and wherein the defining of the updated configuration adds to the ROADM DWDM network at least one pair of transponders, at least one regenerator, or a combination thereof. Next, step 2312 comprises outputting the updated configuration that is defined in order to facilitate physical updating of the ROADM DWDM network in a manner such that the at least one pair of transponders, the at least one regenerator, or the combination thereof is placed into operation. In various embodiments: the configuration that is defined (and/or updated) includes the plurality of ROADM nodes and zero or more in-line amplifiers (ILAs); and the outputting of the configuration that is defined (and/or updated) facilitates physical provisioning and operation of the plurality of ROADM nodes and the zero or more ILAs according to the configuration (and/or updated configuration).

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2E, various steps of a method 2400 according to an embodiment are shown. As seen in this FIG. 2E, step 2402 comprises receiving a first service request. Next, step 2404 comprises responsive to the first service request, obtaining traffic pattern data. Next, step 2406 comprises responsive to the first service request, obtaining parameters associated with components that will be part of a reconfigurable optical add-drop multiplexer (ROADM) network. Next, step 2408 comprises responsive to the first service request, generating a configuration of the ROADM network, wherein the generating of the configuration is based upon the traffic pattern data and the parameters, and wherein the configuration that is generated includes a plurality of ROADM nodes. Next, step 2410 comprises outputting the configuration that is generated in order to facilitate physical provisioning and operation of the plurality of ROADM nodes according to the configuration. Next, step 2412 comprises obtaining first performance monitoring (PM) data that is indicative of operation of the ROADM network as configured according to the configuration. Next, step 2414 comprises generating a first updated configuration of the ROADM network, wherein the generating of the first updated configuration is based at least in part upon the first PM data, wherein the generating of the first updated configuration adds to the ROADM network at least one first pair of transponders, at least one first regenerator, or a first combination thereof, and wherein the first updated configuration is associated with a first wavelength. Next, step 2416 comprises outputting the first updated configuration that is generated in order to facilitate physical updating of the ROADM network in a manner such that the at least one first pair of transponders, the at least one first regenerator, or the first combination thereof is placed into operation. Next, step 2418 comprises receiving a second service request. Next, step 2420 comprises responsive to the second service request, obtaining second PM data that is indicative of operation of the ROADM network as configured according to the first updated configuration. Next, step 2422 comprises responsive to the second service request, generating a second updated configuration of the ROADM network, wherein the generating of the second updated configuration is based at least in part upon the second PM data, wherein the generating of the second updated configuration adds to the ROADM network at least one second pair of transponders, at least one second regenerator, or a second combination thereof, and wherein the second updated configuration is associated with a second wavelength that is different from the first wavelength. Next, step 2424 comprises outputting the second updated configuration that is generated in order to facilitate physical updating of the ROADM network in a manner such that the at least one second pair of transponders, the at least one second regenerator, or the second combination thereof is placed into operation. In various embodiments: the configuration that is generated (an/or updated) includes the plurality of ROADM nodes and zero or more in-line amplifiers (ILAs); and the outputting of the configuration that is generated (and/or updated) facilitates physical provisioning and operation of the plurality of ROADM nodes and the zero or more ILAs according to the configuration (and/or updated configuration).

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2F, various steps of a method 2500 according to an embodiment are shown. As seen in this FIG. 2F, step 2502 comprises receiving, by a processing system including a processor, a service request associated with a new route in a reconfigurable optical add-drop multiplexer (ROADM) dense wavelength-division multiplexing (DWDM) network. Next, step 2504 comprises responsive to the service request, obtaining, by the processing system, traffic pattern data. Next, step 2506 comprises responsive to the service request, obtaining, by the processing system, fiber parameters associated with the new route. Next, step 2508 comprises responsive to the service request, generating, by the processing system, a configuration of the network for the new route, wherein the generating of the configuration is based upon the traffic pattern data and the fiber parameters. Next, step 2510 comprises outputting, by the processing system, the configuration that is generated in order to facilitate physical provisioning and operation of a plurality of ROADM nodes of the new route according to the configuration. Next, step 2512 comprises obtaining, by the processing system, performance monitoring (PM) data that is indicative of operation of the network along the new route as configured according to the configuration. Next, step 2514 comprises generating, by the processing system, an updated configuration of the network, wherein the generating of the updated configuration is based at least in part upon the PM data, wherein the generating of the updated configuration adds to the network along the new route at least one pair of transponders, at least one regenerator, or a combination thereof, and wherein the updated configuration is associated with a wavelength used in the new route. Next, step 2516 comprises outputting, by the processing system, the updated configuration that is generated in order to facilitate physical updating of the network along the new route in a manner such that the at least one pair of transponders, the at least one regenerator, or the combination thereof is placed into operation. Next, step 2518 comprises obtaining, by the processing system, other PM data that is indicative of operation of the network along the new route as configured according to the updated configuration.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments provide for a route planning tool directed to reconfigurable optical add-drop multiplexer (ROADM) dense wavelength-division multiplexing (DWDM) networks. In various embodiments, the route planning tool can integrate performance monitoring data that is obtained from one or more deployed networks.

As described herein, various embodiments integrate the performance monitoring (PM) data of deployed wavelength(s) into the route planning tool to optimize the route planning for new wavelengths (e.g., to optimize for cost savings).

As described herein, various embodiments facilitate integration of performance monitoring (PM) data associated with one or more deployed wavelengths in the field into a route planning tool in order to optimize the route planning for one or more new wavelengths (e.g., in order to facilitate cost savings).

As described herein, various embodiments utilize performance monitoring (PM) data that is fed-back from one or more deployed ROADM DWDM networks. The PM data can be utilized in machine learning in order to optimize one or more ROADM DWDM networks (which can be the same network(s) from which the data is fed-back and/or other network(s)).

As described herein, various embodiments can facilitate cost savings for the deployment of ROADM DWDM networks and/or can facilitate increasing the transmission capacity of such networks.

As described herein, various embodiments can measure how an existing system is performing, and then optimize (e.g., via machine learning) a subsequent system based upon the performance of the existing system (this optimization can result from a new awareness (or comprehensive overview) of existing system performance).

As described herein, various embodiments can operate in order to save the cost of one or more regenerators (which can function to clean a signal being transmitted). For example, based on performance data from an existing network, a prediction can be made that x number fewer regenerators are needed).

As described herein, various embodiments can be implemented via computer-executable instructions that can run on one or more computers, and/or in combination with other program modules and/or as a combination of hardware and software.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A non-transitory machine-readable medium comprising executable instructions that, when executed by a processing system including a processor, facilitate performance of operations, the operations comprising:
receiving traffic pattern data;
receiving parameters associated with components that will be part of a reconfigurable optical add-drop multiplexer (ROADM) dense wavelength-division multiplexing (DWDM) network;
defining a configuration of the ROADM DWDM network, wherein the defining of the configuration is based upon the traffic pattern data and the parameters, and wherein the configuration that is defined includes a plurality of ROADM nodes;
outputting the configuration that is defined in order to facilitate physical provisioning and operation of the plurality of ROADM nodes according to the configuration;
receiving performance monitoring (PM) data that is indicative of operation of the ROADM DWDM network as configured according to the configuration;
defining an updated configuration of the ROADM DWDM network, wherein the defining of the updated configuration is based at least in part upon the PM data, and wherein the defining of the updated configuration adds to the ROADM DWDM network at least one pair of transponders, at least one regenerator, or a combination thereof; and
outputting the updated configuration that is defined in order to facilitate physical updating of the ROADM DWDM network in a manner such that the at least one pair of transponders, the at least one regenerator, or the combination thereof is placed into operation.

2. The non-transitory machine-readable medium of claim 1, wherein the traffic pattern data comprises historic traffic pattern data, predicted traffic pattern data, or any combination thereof.

3. The non-transitory machine-readable medium of claim 1, wherein:
the configuration that is defined includes the plurality of ROADM nodes and one or more in-line amplifiers (ILAs);
the outputting of the configuration that is defined facilitates physical provisioning and operation of the plurality of ROADM nodes and the one or more ILAs according to the configuration; and
the components with which the parameters are associated comprise the plurality of ROADM nodes, the one or more ILAs, the at least one pair of transponders, the at least one regenerator, or any combination thereof.

4. The non-transitory machine-readable medium of claim 3, wherein the parameters comprise, for the plurality of ROADM nodes, the one or more ILAs, or any combination thereof:
one or more of gain, noise figure (NF), polarization dependent loss (PDL).

5. The non-transitory machine-readable medium of claim 3, wherein the parameters comprise, for one or more links of the ROADM DWDM network, one or more fiber parameters.

6. The non-transitory machine-readable medium of claim 5, wherein the one or more fiber parameters comprise:
one or more of fiber type, measured fiber attenuation, estimated fiber attenuation, chromatic dispersion (CD), polarization mode dispersion (PMD), optical return loss (ORL)) for each fiber section along the link between two locations.

7. The non-transitory machine-readable medium of claim 3, wherein the parameters comprise, for the at least one pair of transponders, the at least one regenerator, or any combination thereof:
minimum OSNR requirements.

8. The non-transitory machine-readable medium of claim 1, wherein the configuration comprises a bill of materials (BOM).

9. The non-transitory machine-readable medium of claim 1, wherein:
the configuration that is defined includes the plurality of ROADM nodes and one or more in-line amplifiers (ILAs); and
the PM data comprises first data associated with ROADM node operation and second data associated with ILA node operation.

10. The non-transitory machine-readable medium of claim 9, wherein the PM data comprises span loss values for each section between adjacent ILAs and between adjacent ROADM nodes and ILA nodes.

11. The non-transitory machine-readable medium of claim 1, wherein:
the ROADM DWDM network includes a plurality of spans;
each span of the plurality of spans is between two nodes of the ROADM DWDM network; and
the updated configuration that is defined is based at least in part upon an updated span loss for each span of the plurality of spans.

12. The non-transitory machine-readable medium of claim 1, wherein:
the updated configuration that is defined is based at least in part upon OSNR requirements;
the updated configuration that is defined comprises an assignment of wavelength for the at least one pair of transponders, the at least one regenerator, or the combination thereof; and
the updated configuration that is defined is associated with a bill of materials (BOM).

13. A non-transitory machine-readable medium comprising executable instructions that, when executed by a processing system including a processor, facilitate performance of operations, the operations comprising:
receiving a first service request;
responsive to the first service request, obtaining traffic pattern data;
responsive to the first service request, obtaining parameters associated with components that will be part of a reconfigurable optical add-drop multiplexer (ROADM) network;
responsive to the first service request, generating a configuration of the ROADM network, wherein the generating of the configuration is based upon the traffic pattern data and the parameters, and wherein the configuration that is generated includes a plurality of ROADM nodes;
outputting the configuration that is generated in order to facilitate physical provisioning and operation of the plurality of ROADM nodes according to the configuration;
obtaining first performance monitoring (PM) data that is indicative of operation of the ROADM network as configured according to the configuration;
generating a first updated configuration of the ROADM network, wherein the generating of the first updated configuration is based at least in part upon the first PM data, wherein the generating of the first updated configuration adds to the ROADM network at least one first pair of transponders, at least one first regenerator, or a first combination thereof, and wherein the first updated configuration is associated with a first wavelength;
outputting the first updated configuration that is generated in order to facilitate physical updating of the ROADM network in a manner such that the at least one first pair of transponders, the at least one first regenerator, or the first combination thereof is placed into operation;
receiving a second service request;
responsive to the second service request, obtaining second PM data that is indicative of operation of the ROADM network as configured according to the first updated configuration;
responsive to the second service request, generating a second updated configuration of the ROADM network, wherein the generating of the second updated configuration is based at least in part upon the second PM data, wherein the generating of the second updated configuration adds to the ROADM network at least one second pair of transponders, at least one second regenerator, or a second combination thereof, and wherein the second updated configuration is associated with a second wavelength that is different from the first wavelength; and
outputting the second updated configuration that is generated in order to facilitate physical updating of the ROADM network in a manner such that the at least one second pair of transponders, the at least one second regenerator, or the second combination thereof is placed into operation.

14. The non-transitory machine-readable medium of claim 13, wherein the ROADM network is a dense wavelength-division multiplexing (DWDM) network.

15. The non-transitory machine-readable medium of claim 13, wherein each of the first PM data and the second PM data is obtained from an element management system (EMS).

16. The non-transitory machine-readable medium of claim 15, wherein:
the processing system is part of a first computer and the EMS is part of a second computer, which is separate from the first computer; or
the processing system is part of a computer, and the EMS is part of the computer.

17. The non-transitory machine-readable medium of claim 13, wherein:
the configuration that is generated includes the plurality of ROADM nodes and one or more in-line amplifiers (ILAs);
the outputting of the configuration that is generated facilitates physical provisioning and operation of the plurality of ROADM nodes and the one or more ILAs according to the configuration;
the first PM data comprises span loss data; and
the second PM data comprises one or more of pre forward error correction (preFEC) bit error rate (BER) data, post forward error correction (postFEC) BER data, chromatic dispersion (CD) data, polarization mode dispersion (PMD) data, polarization dependent loss (PDL) data, or any combination thereof.

18. The non-transitory machine-readable medium of claim 13, wherein:
an artificial intelligence (AI) or machine learning (ML) process is used for one or more of:
generating the configuration of the ROADM network;
generating the first updated configuration of the ROADM network;
generating the second updated configuration of the ROADM network.

19. A method, comprising:
receiving, by a processing system including a processor, a service request associated with a new route in a reconfigurable optical add-drop multiplexer (ROADM) dense wavelength-division multiplexing (DWDM) network;
responsive to the service request, obtaining, by the processing system, traffic pattern data;
responsive to the service request, obtaining, by the processing system, fiber parameters associated with the new route;
responsive to the service request, generating, by the processing system, a configuration of the network for the new route, wherein the generating of the configuration is based upon the traffic pattern data and the fiber parameters;
outputting, by the processing system, the configuration that is generated in order to facilitate physical provisioning and operation of a plurality of ROADM nodes of the new route according to the configuration;
obtaining, by the processing system, performance monitoring (PM) data that is indicative of operation of the network along the new route as configured according to the configuration;
generating, by the processing system, an updated configuration of the network, wherein the generating of the updated configuration is based at least in part upon the PM data, wherein the generating of the updated configuration adds to the network along the new route at least one pair of transponders, at least one regenerator, or a combination thereof, and wherein the updated configuration is associated with a wavelength used in the new route;
outputting, by the processing system, the updated configuration that is generated in order to facilitate physical updating of the network along the new route in a manner such that the at least one pair of transponders, the at least one regenerator, or the combination thereof is placed into operation; and
obtaining, by the processing system, other PM data that is indicative of operation of the network along the new route as configured according to the updated configuration.

20. The method of claim 19, wherein:
the PM data comprises for one or more spans, respective span loss data;
the other PM data comprises for each of the at least one pair of transponders, the at least one regenerator, or the combination thereof one or more of pre forward error correction (preFEC) bit error rate (BER) data, post forward error correction (postFEC) BER data, chromatic dispersion (CD) data, polarization mode dispersion (PMD) data, polarization dependent loss (PDL) data, or any combination thereof; and
the generating of the configuration is further based upon additional PM data related to one or more other networks.
